(19) United States
(12) Patent Application Publication
(10) Pub. No.: US 2012/0268665 A1
(43) Pub. Date: Oct. 25, 2012

(54) Vehicle with Flexible Display

(75) Inventors: Arjun Yetukuri, Rochester Hills, MI (US); Jeff Frelich, Commerce, MI (US); Don Bernhardt, Walled Lake, MI (US); David Hein, Sterling Heights, MI (US); Thomas S. Hicks, Livonia, MI (US)

(73) Assignee: LEAR CORPORATION, Southfield, MI (US)

(21) Appl. No.: 13/508,588

(22) PCT Filed: Nov. 19, 2009
(86) PCT No.: PCT/US09/65043

§ 371 Date: May 8, 2012

(51) Int. Cl. H04N 5/64

(52) U.S. Cl. 348/837; 348/E05.128

(57) ABSTRACT

A vehicle has self-contained, stand-alone flexible displays in a wide variety of locations and serving a wide variety or purposes, such as entertainment, safety warnings, operating instructions, maps, vehicle information, etc. The displays may be positioned on a vehicle interior component having a contoured surface profile, or may be movable from a generally concealed storage position to an extended position. The display may be rolled like a scroll in a storage position. The displays may show a single picture, multiple pictures on sequential frames, interactive videos, etc. and may include audio information, touch screen switches, etc.

### FIELD OF THE INVENTION

The present invention relates generally to vehicle displays and more specifically to flexible displays used in vehicles.

### BACKGROUND OF THE INVENTION

A wide variety of information is displayed within a vehicle, ranging from simple tags and labels, such as air bag warning labels, to television and videos. Many such displays involve hardware and systems which typically are designed for specific applications for reasons of size, mounting, power sourcing, etc.

Typically, displays such as LCD displays are used only in a flat and/or non-flexible surface application. However, flexible display screens mounted on a rigid substrate such as a vehicle component have been proposed for vehicle use. The flexibility allows the display to confirm to a curved or irregularly shaped rigid substrate. However, the use of a vehicle component as a substrate limits the use of such displays.

### SUMMARY OF THE INVENTION

The present invention is vehicle having a self-contained, stand-alone flexible display. The invention provides interior designers with enhanced flexibility and aesthetics and allows for use in a wider variety of locations and for a wider variety of purposes within a vehicle. The present invention may include a display which may be placed over a vehicle interior component having a contoured surface profile. The present invention may also include a display which is movable from a generally concealed storage position to an extended position. In the storage position, the display may be in a rolled or scroll-like configuration.

The displays of the present invention may be used to communicate a wide variety of information, such as safety warnings, operating instructions, entertainment, etc., and may be attached to a variety of vehicle components. The displays may show a single picture, multiple pictures on sequential frames, interactive videos, etc. and may include audio information, touch screen switches, etc.

The present invention utilizes display screens which have less mass than conventional display screens, are generally easier to assemble and service, and which take up less space, all of which create more styling options than previously used devices.

The present invention further relates to various features and combinations of features shown and described in the disclosed embodiments.

### BRIEF DESCRIPTION OF THE DRAWINGS

FIG. 1 is a perspective view of a vehicle head restraint with a display screen.

FIG. 2 is a perspective view of a vehicle seat with a display screen.

FIGS. 3 and 3A are perspective views of a vehicle seat latch handle with a display screen.

FIG. 4 is a perspective view of a vehicle trunk storage compartment door with a display.

FIG. 5 is another perspective view of a vehicle seat with a display screen.

FIGS. 6 and 7 are perspective views of a vehicle head restraint with alternative display screens.

FIG. 8 is a perspective view of a vehicle headliner with a display screen.

FIGS. 9-14 are perspective views of rolled display screens attached to various vehicle components.

FIG. 15 is a perspective view of a pull-out display screen attached to a vehicle seat component.

FIG. 16 is a perspective view of display screen tag attached to a vehicle seat component.

FIG. 17 is a perspective view of a vehicle steering wheel with display screens.

FIG. 18 is a perspective view of a vehicle door with a display screen.

### DETAILED DESCRIPTION OF PREFERRED EMBODIMENTS

All of the preferred embodiments utilize a thin, self-contained, stand-alone flexible display screen. Such screens, also referred to as e-paper or roll-up displays, may be available from E Ink Corporation, Kent Displays, Inc., SiPix Imaging, Inc., Sony, and Samsung. This type of display screen has been proposed for non-vehicle uses such as price tags and shelf labels.

The screens generally are made with thin film transistors integrated into metal foil or a thin sheet of flexible plastic. LCD, OLED and e-ink technology may be used. The screens are self-contained and stand-alone in that mounting on a vehicle component substrate or other rigid or non-rigid substrate is not required. The screens may display diagrams, pictures, a series of diagrams and pictures, instructional and entertainment videos, etc. This invention contemplates the addition of touch screen switches to the display screens.

Preferably the screens are hard wired to a software control module, typically a circuit board located adjacent the screen and connected to the screen by a flexible connector or similar device. Information, such as short instructional videos, may be permanently hard coded onto the control module or accessible through a separate device such as a flash memory. This mounting configuration would be preferred only for permanent videos because access typically would be relatively difficult. In addition, screens may be connected to a video source such as an iPod or CD or DVD player, through a USB port, for example, as is well known in the art. Screens can be battery powered, but preferably are wired to the vehicle electrical system so that battery replacement is not an issue.

Any audio component of a video or other message may be broadcasted by various methods well known in the art, such as through the vehicle sound system, or could be broadcasted to headphones using radio frequency, infrared or other well known technologies.

Referring to FIG. 1, a vehicle seat 10 and head restraint 12 are covered with a suitable trim such as leather or vinyl. For rear seat occupant entertainment and information, a self-contained, stand-alone flexible entertainment display screen 14 is integrated into the trim cover, such as by sewing. Other attachment methods can be used, such as adhesives or mechanical methods. In the preferred embodiment of FIG. 1, the screen 14 is part of the head restraint trim. In other words, the screen is not attached to a trimmed head restraint. The head restraint 12 has a curved outer surface to which the screen 14 conforms. This embodiment can also be used for vehicle aftermarket applications, as head restraints can be replaced easily.

The display screen 14 preferably is wired to the vehicle electrical system through the head restraint and seat and is connected to a video source such as an iPod or CD or DVD player. Short videos, such as instructional videos, may be hard coded into a control module or accessible through a separate device such as a flash memory which could be mounted within the head restraint 12. Access to longer videos, such as entertainment videos, would preferably be through a player, such as a multi-disc changer, which could be located anywhere in the vehicle remote from the screen 14. Longer videos may also be available with flash drives plugged into a control module located in the head restraint.

FIG. 2 shows the vehicle seat 10 having a self-contained, stand-alone flexible information display screen 16 attached to and extending from the seat trim seam 18. The screen, which is in the form of a permanently displayed tag or label, may be attached by sewing, adhesives or mechanical means. The screen 16 could be adapted to display several items of information, simultaneously or sequentially, such as whether the airbag is active or whether the head restraint or the safety restraint system is present. The information or screen background may be displayed in different colors, depending on the information provided. A screen control module may be located in the seat adjacent the screen and may be activated upon an event such as a door opening.

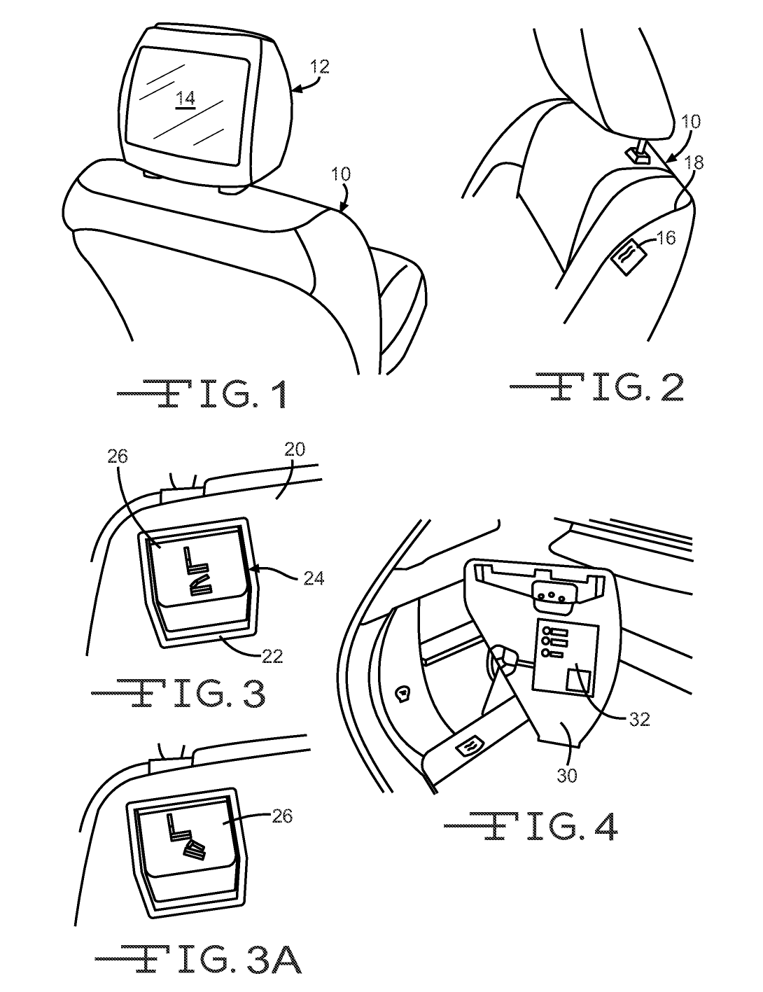

FIG. 3 shows the vehicle seat 20 having seat-back latch. The latch includes a frame or bezel 22 and a latch handle 24. A flexible instructional display screen 26 is attached to the latch handle 24. Preferably, the display is activated upon being touched. The screen 26 displays, in two pictures in this embodiment, the seat back being moved to the stow position. When the seat is moved from the stow position, the screen may change to show illustrations of the next step of the instructions, such as shown in FIG. 3A. Alternatively, the screen may display the pictures one at a time in sequence. Sequencing may be set by a timer or could be done upon certain movements of the latch or the seat. Other informational depictions could be used, such as a video depiction of the seat being moved. As with all other embodiments, the display may be in black and white or color.

FIG. 4 shows a vehicle spare tire storage compartment door 30 having a flexible information display screen 32 attached to its inside surface. The vehicle depicted is an SUV but the door may also be in a vehicle trunk. The screen may display, for example, instructions on safely changing a tire. The instructions may be a series of pictures or written instructions, given together or in sequence, or could be an instructional and interactive video.

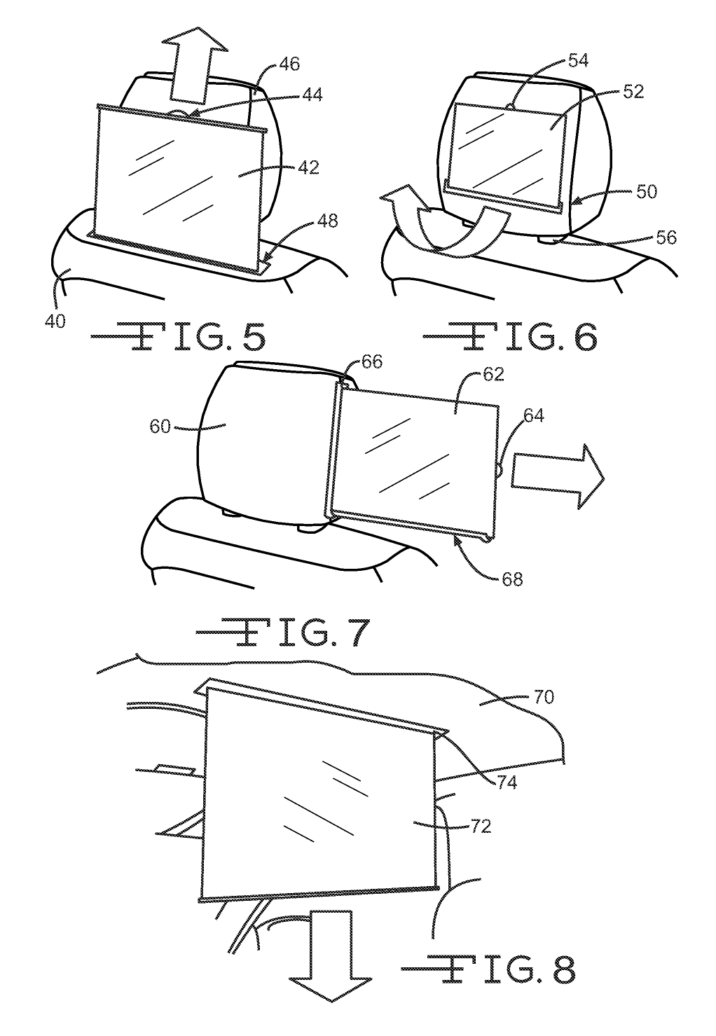

The display screens of FIGS. 1-4 are all thin profile screens which are attached for permanent display; that is, they are always visible. The embodiments of FIGS. 5-16 are thin profile self-contained, stand-alone flexible information display screens which are movable from a storage position in which they are generally concealed by a vehicle component to an extended position in which they are visible. Generally, it is preferred that the screens are dormant or inactive in the stored position and become active when moved into an extended position.

In the FIG. 5-16 embodiments, it is preferred that the screen be rolled onto itself in a scroll-like manner when in the storage position. The rolled configuration is a more compact configuration and is particularly suitable for vehicle component storage applications. However, it is possible that the screen in each embodiment remains in an unrolled configuration, thereby entering a storage position in the same manner as a vehicle door window. In either case, the vehicle component to which the screen is attached includes a slot, generally of the same or slightly larger width of the screen, through which the screen can be retracted to a storage or inactive position in which it is not visible from within the vehicle passenger compartment. If the screen is designed to be manually extended from its storage position, it generally has a small handle attached to a stabilizing bar which rests adjacent the vehicle component slot when the screen is in a retracted position.

The screens of FIGS. 5-16 generally have a handle by which they can be pulled to an extended position. A spring or other mechanical means can be used to retract the scroll-like screens in a manner similar to that used for window blinds, as is well known to those skilled in the art. Alternatively, a small motor, preferably located within an adjacent vehicle component, can be used to retract the screen. The same motor could be used to extend the screen and could be activated automatically upon an event such as a door opening, a seat belt extending, etc.

FIG. 5 shows an extendible flexible display screen 42 attached to a vehicle seat 40. The screen 42 has a handle 44 which is used to pull the screen from the retracted position. The handle 44 may also serve as a latch for attachment to the head restraint 46 to maintain the screen in the extended position. The screen 42 extends from the interior of the seat 40 through a slot 48. The screen 42 is attached to the interior of the seat 40 below the slot 48. The screen is a roll-up type screen. As such, the screen takes up only a small space below the slot 48. Alternatively, the screen could be rigid and extend into the seat in an unrolled configuration because there is space within the seat for this configuration.

FIG. 6 shows an extendible flexible display screen 52 attached to the lower portion of a vehicle head restraint 50. The screen 52 has a latch 54 or other means for attachment to the head restraint 50 to maintain the screen in the extended position. The screen 52 extends from the interior of the head restraint 50 through a slot 56. The screen 52 is attached to the interior of the head restraint 50 horizontally within the slot 56. The screen 52 is a roll-up type screen. In this embodiment, the screen 52 must be pulled horizontally outwardly from the head restraint slot 56 and then extended upwardly to the latch 54. In this embodiment, a rigid screen would generally be unacceptable because of the limited horizontal space available within the head restraint. It is also possible to attach the screen to the upper end of the head restraint.

FIG. 7 shows a flexible display screen 62 attached to a vehicle head restraint 60 and extendible in a horizontal direction by pulling a handle 64. The screen 52 extends from the interior of the head restraint 60 through a vertical slot 66. The screen 62 is attached to the interior of the head restraint 60 within the slot 56. The screen 62 is a roll-up type screen, but a rigid screen could be used in this application. The screen 62 is maintained in the extended position shown by a rigid stabilizer 68 which can be retracted into the head restraint. Alternatively, the stabilizer 68 could be a telescoping rod rather than a rigid rod. In addition, the stabilizer 68 could be mounted to fold upwardly (as viewed in FIG. 7) to fit against or within slot 66 for storage and to flip down to secure the screen in its extended position.

FIG. 8 shows an extendible flexible display screen 72 attached to a vehicle headliner 70. The screen 72 is a roll-up type screen which extends downwardly from the headliner. A latch may be used to maintain the screen in an extended position as is well known in the art. The screen 72 extends from above the headliner where it is attached to the vehicle roof through a slot 74. In this embodiment, the screen is shown between the driver and front passenger seats. However, it is contemplated that other headliner locations be used, and that multiple screens may be used in the headliner of a vehicle. For example, two screens may be positioned in the same plane, above each of the driver and front passenger seats, respectively. Alternatively, screens may be spaced from the front to the back of the vehicle, especially in larger passenger vehicle such as vans or busses. The headliner screens are especially suitable for entertainment, but may also be used to display safety or other information.

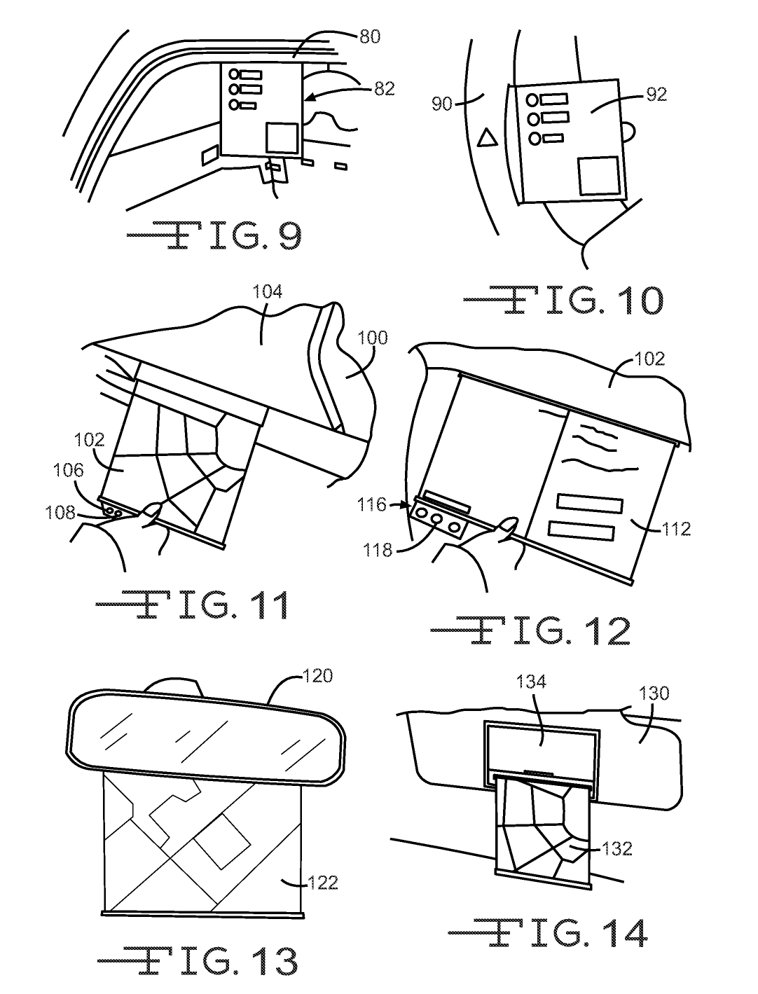

FIG. 9 shows an extendible flexible display screen 82 attached to a vehicle headliner 80 adjacent a rear hatch door frame. The screen 82 is a roll up type screen which extends downwardly from the headliner 80. FIG. 10 shows a horizontally extendible flexible display screen 92 attached to the trim 90 of a rear compartment or trunk. The screen 92 is a roll up type screen which extends horizontally outwardly from the trim 90. Screens 82 and 92 are extendable in the same manner as previously described embodiments. Display screens positioned in the cargo or trunk region may best be used to displays tire changing procedures, either with a series of pictures or videos an interactive video.

FIG. 11 shows an extendible flexible display screen 102 attached to a vehicle instrument panel 100 below the glove box door 104. Screen 102 is stored inside of the glove box. FIG. 12 shows an extendible flexible display screen 112 attached to the instrument panel 100 above the glove box door 104. Screen 112 may be stored within or above the glove box. Screens 102 and 112 preferably are roll-up type screens, but rigid screens may be used for these applications. Screens 102 and 112 are retractable as previously described. Screens 102 and 112 may best be suited for informational displays, such as interactive maps 102 and interactive service manuals 112. Screens 102 and 112 include interactive switch panels 106 and 116, respectively, to allow input for interactivity. Switches 108 and 118 may be touch screen switches for such input and may be used to control the screen image or sound volume, choose, scroll or enlarge an image on the screen, etc.

FIG. 13 shows a roll-up type flexible display screen 122 attached to the driver rearview mirror 120. This location is preferred for displaying navigation information such as a map. Because the screen may extend somewhat between the vehicle driver and the windshield, it is preferred that the screen have variable opacity to minimize driver view obstruction. Variable opacity may be obtained using a variable transmissive device such as an electrochromic dimmer disclosed in U.S. Pat. No. 6,542,146, which is owned by the assignee of the present invention and hereby incorporated by reference in its entirety into this specification.

FIG. 14 shows a roll-up type extendible flexible display screen 132 attached to the passenger side sun visor adjacent the mirror door 134. This is another location which is preferred for displaying navigation information such as a map. As with the embodiment shown in FIG. 13, the screen 132 may extend somewhat between a vehicle occupant and the windshield. It is also preferred that the screen 132 have variable opacity to minimize driver view obstruction.

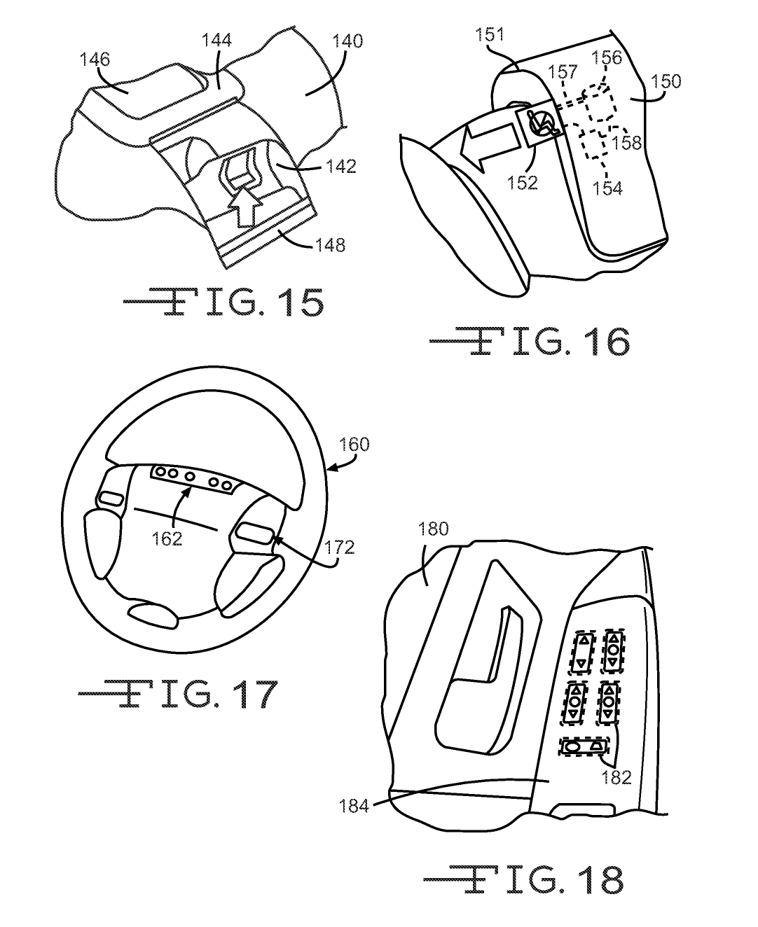

FIG. 15 shows an extendible flexible display screen 142 attached to a vehicle seat 140 adjacent the seat back latch bezel 144. Screen 142 may be a roll-up type screen, but a pop-out (non-roll-up) screen is preferred for this application because the screen is relatively small, e.g. less than about 3 inches in length. Screen 142 may best be suited for informational displays, such seat back reclining instructions. The display may be a mere picture or series of pictures, or could be a video or animation. The screen could be extended either manually with a handle 148 or automatically by a small motor upon touching of the latch handle 146 or opening of an adjacent door.

FIG. 16 shows an extendible flexible display screen 152 attached to a vehicle head restraint 150 at the trim seam 151. The screen 152 displays a safety warning. The display 152 could be a roll-up type screen, but a pop-out screen is preferred for this application because of the relatively small size of the screen. Alternatively, the screen 152 could be non-retractable, and normally dormant with a blank screen which is activated by trigger events such as those mentioned below.

Preferably, screen 152 is normally in a retracted position hidden from view. The screen will be automatically extended upon the occurrence of one or more events, such as (a) a passenger occupying an associated seat, and (b) an associated head restraint 150 being positioned or moved into a lowered non-use position. A small motor 156 may be located within the head restraint 150 or within an associated or adjacent seat and may extend and/or retract the screen 152 through a linkage 157. A screen control module 154 may also be located in the head restraint or an associated or adjacent seat and wired to the motor and screen through wiring 158. The screen may include a video warning and an audio warning.

FIG. 17 shows a vehicle steering wheel assembly 160 having a fixed flexible display screen 162 attached to the central portion. The screen 162 may display vehicle information typically displayed in the instrument panel, such as engine warning signals, oil level signals, seat belt signals, etc. The screen 162 preferably replaces a section of the leather or vinyl steering wheel trim, but alternatively may be attached over a section of the trim, by sewing or other attachment means.

FIG. 17 shows a second fixed flexible display screen 172 attached to the central portion of the steering wheel assembly to provide touch screen switches for various controls, such as speed controls, radio controls, signals, etc. Similar screens can provide touch screen switches for door locks, window controls, etc. Such switches are wired to the vehicle electronics as usual.

FIG. 18 shows a vehicle personnel door 180 having five flexible display screens 182 which are part of the door trim 184. The display screens 182 may be integrated into the trim by sewing, but other attachment methods can be used, such as adhesives or mechanical methods. The flexible screens 182 conform to any curvature of the door. In this embodiment, the flexible screens 182 include touch screen switches for window controls and door locks.

The embodiments of the invention which have been illustrated and described are not intended to depict all forms of the invention, as various modifications may be made without departing form the spirit and scope of this invention as defined in the following claims.

1. A vehicle having a vehicle component, a self-contained flexible display attached to the vehicle component, and a control module for controlling an image displayed on the flexible display.

2. A vehicle as defined in claim 1 wherein the flexible display is movable from a storage position in which the flexible display is generally concealed by a vehicle component to an extended position.

3. A vehicle as defined in claim 2 wherein the flexible display is movable from the storage position to the extended position in reaction to a change in condition of a vehicle component.

4. A vehicle as defined in claim 2 wherein the flexible display is in a rolled configuration in the storage position.

5. A vehicle as defined in claim 2 further comprising a motor adapted to extend the flexible display from the storage position to the extended position and to retract the flexible display from the extended position into the storage position.

6. A vehicle as defined in claim 1 wherein the flexible display is attached to at least one of a head restraint, headliner, dashboard, visor, mirror, seat latch, trim member, glove box, personnel door, compartment door, door frame, seat, and steering wheel.

7. A vehicle as defined in claim 6 wherein the flexible display is attached to a trim member, wherein the trim member is door trim member or a steering wheel trim member.

8. A vehicle as defined in claim 1, wherein the flexible display comprises a touch switch.

9. A vehicle as defined in claim 1 further comprising a control module electrically connected to the display, the control module located within an adjacent vehicle component.

10. A vehicle as defined in claim 1 wherein the flexible display has variable opacity.

11. A vehicle as defined in claim 1 wherein the flexible display is attached to a steering wheel and displays driver information.

12. A vehicle as defined in claim 1 wherein the flexible display shows information which is provided in the vehicle owner, operator, or service manual.

13. A vehicle as defined in claim 1 wherein the flexible display moves from a retracted position to an extended position upon the occurrence of a predetermined event.

14. A vehicle as defined in claim 1 wherein the flexible display changes from a dormant condition to an activated condition upon the occurrence of a predetermined event.

15. A vehicle as defined in claim 1 wherein an image on depicted on the flexible display changes upon the occurrence of a predetermined event.

16. A vehicle as defined in claim 1 wherein the color of the flexible display changes upon the occurrence of a predetermined event.

17. A vehicle as defined in claim 1 wherein the control module triggers an audio message upon the occurrence of a predetermined event.

18. A vehicle component having a trim covering, the trim covering comprising a self-contained flexible display.

19. A vehicle component as defined in claim 18 wherein the vehicle component comprises a vehicle head restraint.

20. A vehicle component as defined in claim 18 wherein the vehicle component comprises a door trim and the flexible display comprises a touch switch to operate a vehicle window or vehicle door lock.
